(19) United States
(12) Patent Application Publication
(10) Pub. No.: US 2024/0352594 A1
(43) Pub. Date: Oct. 24, 2024

(54) OFFSHORE ELECTROLYSIS PLANT AND METHOD FOR OPERATING AN OFFSHORE ELECTROLOSIS PLANT

(71) Applicant: Siemens Energy Global GmbH & Co. KG, München (DE)

(72) Inventors: Marc Hanebuth, Nürnberg (DE); Michel Suermann, Erlangen (DE); Dan Taroata, Erlangen (DE)

(21) Appl. No.: 18/574,783

(22) PCT Filed: May 4, 2022
(86) PCT No.: PCT/EP2022/061980

§ 371 Date: Dec. 28, 2023

(30) Foreign Application Priority Data
Jun. 30, 2021 (EP) 21182686.2

(51) Int. Cl. C25B 1/04; C25B 9/67; C25B 15/021

(52) U.S. Cl. CPC C25B 1/04; C25B 9/67; C25B 15/021

(57) ABSTRACT

The invention relates to an offshore electrolysis plant including an electrolyzer, which is disposed in a container, and a heat exchanger, which is designed to absorb process heat from the electrolysis and to discharge said process heat out of the container in a closed coolant circuit. A coolant pump for conveying the coolant in the coolant circuit is disposed in the container. The invention also relates to a method for operating an offshore electrolysis plant having an electrolyzer disposed in a container. In the method, in order to absorb process heat from the electrolysis and to discharge said process heat out of the container, coolant is conducted in a closed coolant circuit, wherein a coolant pump disposed in the container is operated.

### BACKGROUND

The invention relates to an offshore electrolysis plant and a method for operating an offshore electrolysis plant.

An electrolysis plant is a device which induces a material conversion (electrolysis) with the aid of electric current. Corresponding to the variety of different electrochemical electrolysis processes, there is also a variety of electrolysis plants, such as an electrolysis plant for water electrolysis.

Hydrogen is currently produced, for example, by means of proton exchange membrane (PEM) electrolysis or alkaline electrolysis from water. The electrolysis plants produce hydrogen and oxygen from the supplied water with the aid of electrical energy. This process takes place in an electrolysis stack, composed of multiple electrolysis cells. Water is introduced as the educt into the electrolysis stack under DC voltage, wherein two fluid flows, consisting of water and gas bubbles (O₂ or H₂), exit after passing through the electrolysis cells.

Current considerations are directed toward producing raw materials using excess energy from renewable energy sources in times having a large amount of sun and a large amount of wind, thus having above average solar current or wind power generation. One raw material can be hydrogen in particular, which is produced by water electrolysis plants. For example, so-called EE gas can be produced by means of hydrogen. An EE gas is a combustible gas which is obtained from renewable sources with the aid of electrical energy.

Hydrogen represents a particularly environmentally friendly and sustainable energy carrier here. It has the unique potential of implementing energy systems, transportation, and large parts of chemistry without CO₂ emissions. To succeed in this, however, the hydrogen cannot originate from fossil sources, but rather has to be produced with the aid of renewable energy.

One source for renewable energies is wind power. Large amounts of electric power may be implemented in particular using so-called offshore wind turbines close to the coast. However, it is challenging in this case that a large distance has to be overcome to the consumers. The energy is thus to be transported to the consumer with as little loss as possible. Hydrogen is very well suitable as a transport medium. This can be transported, for example, by pipelines in gaseous form. One positive secondary aspect in this case is that a hydrogen-conducting pipeline can fulfill the function of an energy storage device at the same time, since the internal pressure can be varied within certain limits. From this consideration, producing the hydrogen directly at the location of obtaining energy is of particular interest, thus placing electrolysis plants offshore directly at offshore wind turbines or in the immediate vicinity thereof.

In offshore electrolysis plants, particular attention has to be directed to avoiding corrosion, because significantly higher corrosion rates can occur due to the presence of saltwater, which endangers a longer interruption-free operation of an electrolysis plant. In principle, offshore electrolysis plants can be equipped with electrolyzers and these can be housed inside closed housings, the containers. A certain protection from the external environmental influences can thus be achieved for the electrolyzer. However, the electrolyzer has to be cooled because of operation in order to dissipate the waste heat arising from the electrolysis process to the surroundings. Efficient cooling and waste heat utilization of an onshore electrolysis plant is described, for example, in EP 2 623 640 A1. The efficiency of an electrolyzer for producing hydrogen and oxygen by decomposing water is increased by storing waste heat generated in the electrolyzer in a heat carrier medium, supplying the heat carrier medium to a water processing plant, and producing deionized water from untreated water by means of the waste heat in the water processing plant. The heat carrier medium is recirculated in a closed circuit between the electrolyzer and the water processing plant in this case. A respective heat exchanger ensures absorption and dissipation of the heat from the housing of the electrolysis plant and a corresponding heat exchange and supply to the water processing plant.

In comparison thereto, the cooling requirements in operation in offshore electrolysis plants are very particularly important due to a closed container construction, thus housing and protection of the electrolyzer, in order to avoid overheating and failure. An interface between electrolyzer and the surroundings is therefore ultimately unavoidable in an offshore electrolysis plant in order to suitably dissipate the heat flow of the process heat and enable safe operation. At the same time, environmental aspects in the maritime area are considerable, in particular regulatory specifications for protecting the maritime fauna and flora.

### SUMMARY

Embodiments include an offshore electrolysis plant including an electrolyzer, which is disposed in a container, and a heat exchanger, which is designed to absorb process heat from the electrolysis and to discharge said process heat out of the container in a closed coolant circuit. A coolant pump for conveying the coolant in the coolant circuit is disposed in the container.

Embodiments also include a method for operating an offshore electrolysis plant having an electrolyzer disposed in a container. In the method, in order to absorb process heat from the electrolysis and to discharge said process heat out of the container, coolant is conducted in a closed coolant circuit, wherein a coolant pump disposed in the container is operated.

### DETAILED DESCRIPTION

The object of the present invention is therefore to specify an offshore electrolysis plant which enables operation that is safe and environmentally friendly at the same time. A further object is to specify a method for operating an offshore electrolysis plant.

The object directed to an offshore electrolysis plant is achieved according to the invention by an offshore electrolysis plant comprising an electrolyzer arranged in a container, and a heat exchanger which is designed for heat absorption and dissipation of process heat from the container from the electrolysis in a closed coolant circuit, wherein a coolant pump for conveying the coolant in the coolant circuit is arranged in the container.

The object directed to a method for operating an offshore electrolysis plant is achieved according to the invention by a method for operating an offshore electrolysis plant having an electrolyzer arranged in a container, in which coolant is guided from the container in a closed coolant circuit for the heat absorption and dissipation of process heat from the electrolysis, wherein a coolant pump arranged in the container is operated.

The advantages and preferred embodiments described hereinafter with respect to the offshore electrolysis plant may be transferred accordingly to the method for operating the electrolysis plant.

The invention is already directed to the finding in this case that the higher-performance offshore wind turbines, which are being installed to a greater extent, and the growing electrical generation performance thereof accordingly require higher-performance electrolysis plants. It is therefore expected that the performance class of an offshore electrolysis plant and the number thereof will accordingly rise strongly in the future. Rising requirements for the safe and environmentally-friendly operation in the maritime environment accompanying this are to be taken into consideration. Due to the efforts in scaling toward larger offshore electrolysis plants, the question of environmental compatibility has entered the focus of the discussion. Operation with the fewest possible interventions under environmental aspects is to be ensured in this case. Solving the cooling problem for operation is therefore particularly important with operational reliability and performance of the offshore electrolysis plant at the same time.

The offshore electrolysis plant according to the invention recognizes and overcomes the disadvantages of conventional cooling approaches for the cooling medium here for the first time. For example, a concept according to which the ocean water is pumped directly as a cooling medium for a heat exchanger out of the ocean and removed and is conducted directly back into the ocean after the application of the process heat of the offshore electrolysis plant and heat exchange to the seawater. This proves to be very disadvantageous and moreover maintenance-intensive under environmental aspects.

Other concepts for cooling by means of ambient air require large heat exchanger surfaces with the atmosphere and extensive fan systems or blowers for cooling air supply, in order to achieve the required cooling performance. Such systems in offshore use are very susceptible, due to the direct exposure to salt-containing aerosols in the maritime area, to failure due to corrosion and require a significant maintenance expenditure.

These disadvantages are overcome by the invention and safer and more environmentally-friendly operation is enabled of an offshore electrolysis plant in a closed container construction having an electrolyzer arranged in the container, for example, a PEM electrolyzer for hydrogen production, and having a coolant pump arranged in the container or a coolant pump flanged tightly on the container. In the latter case, a housing unit is formed between the container and the flanged-on coolant pump, so that the coolant pump is also arranged in the container within the meaning thus understood. The heat absorption of the process heat from the electrolysis at the plant via the heat exchanger in the container is achieved using the closed cooling circuit. Both a use by sucking in ocean water and circulating it for cooling purposes and also the significant corrosion problems in the case of air cooling with open cooling operation at sea are avoided. The invention follows a different path here than the conventional offshore plants using open cooling.

In particular because no seawater is sucked in and instead a closed coolant circuit is provided, the above-described problems are avoided. No foreign bodies can be sucked in, undesired inorganic layers or biofouling cannot form in the interior of the heat exchanger, which increases the operational reliability. In particular, no heated water is discharged to the surroundings. A further advantage is that, for example, in addition to (potable) water, other particularly suitable cooling media or additives can be used in the closed cooling circuit, which can then significantly reduce the required heat exchange performance or design of the required services for the heat absorption of the process heat from the container at a high temperature level, the discharge thereof, and finally transfer to a suitable heat sink.

A coolant pump for conveying the coolant is arranged here in the offshore electrolysis plant in the coolant circuit. The coolant pump is designed in accordance with the cooling performance. The coolant pump is therefore housed in the container itself for protection from weather influences, for example, in the vicinity of the electrolyzer to be cooled of the offshore electrolysis plant. In principle, fixed coupling by tight flanging of the coolant pump directly on the container, for example, from the outside, is also possible here, so that then an integral housing unit of the coolant pump with the container is formed. The protective and cooling concept is therefore to be understood in the scope of the invention such that even in the case of flanging on, screwing on, or another type of direct coupling of the coolant pump on the container, the electrolyzer and the coolant pump are considered to be housed in the same container, wherein a housing unit is formed. This is particularly advantageous for maintenance and inspection purposes on the coolant pump, since a facilitated access to the coolant pump from the outside is possible if needed. The particularly sensitive devices such as the electrolyzer, the heat exchanger, and the coolant pump for offshore use in particular are protected in this way and the offshore electrolysis plant is accordingly finished in a special manner for offshore operation.

According to one embodiment, a heat exchanger having a correspondingly extensively dimensioned heat exchanger surface, which is immersible in the ocean, is provided in the closed coolant circuit for the heat emission of the process heat absorbed by the coolant. Due to the integration of a heat exchanger designed having a correspondingly extensively dimensioned heat exchanger surface in the closed cooling circuit, particularly effective coupling to the selected heat sink, the ocean water, is achieved and a heat exchange of the dissipated process heat from the extensive heat exchanger to the ocean water is achieved by the immersibility. The coolant circuit having the cooling medium which is independent of the ocean water proves to be particularly advantageous in this case.

The invention therefore provides the use of ocean water as a heat sink in a nearby large reservoir of cooling medium, wherein only the heat is emitted by the heat exchanger immersed in the ocean using a closed cooling circuit. High cooling performances are hereby implementable for the electrolysis and large heat flows from high performance offshore electrolyzers are transferable via the coolant to the ocean water. The impact of this design under environmental aspects is minor, in particular since a material decoupling of coolant and ocean water is provided. Suitably finished pivot devices and/or lifting tools are provided on the offshore electrolysis plant for the immersibility of the heat exchanger in the ocean water, which enable corresponding movements of the heat exchanger such as immersing or lifting out.

The generally relatively large exchange surface for the extensive heat exchanger can be dimensioned and structurally embodied with regard to the required cooling performance by a corresponding thermal-technology design. In contrast to the open cooling concepts, it is no longer necessary to remove the ocean water via pumps, convey it actively to the water surface, and supply it directly for the cooling task of the offshore electrolysis plant. Instead, the heat dissipation is only carried out indirectly via the extensive heat exchanger via convection in the ocean water.

To provide a large heat exchange area, the heat exchanger, in particular the extensive heat exchanger, advantageously has a pipeline which is embodied with ribs and/or fins on the coolant-guiding pipe outer surface and/or is guided in a large number of pipe curves.

These structural measures using a pipeline or pipeline bundle are taken to increase the surface area for efficient heat exchange. Various options come into consideration here, for example, that the heat exchanger can be embodied as a meandering pipe and/or a pipe provided with fins. Furthermore, for example, as in the case of a pipe bundle heat exchanger, the volume flow of the coolant can be divided onto multiple parallel pipelines in order to thus obtain a larger heat exchange area.

In one advantageous embodiment, the pipeline, in particular the pipeline bundle, is made of steel, preferably a corrosion proof stainless steel. Furthermore, the pipeline, in particular the pipeline bundle, has a corrosion protection layer on the outer surface for this purpose.

In principle, the extensive heat exchanger that is immersed in the ocean water can be made of steel. However, measures are preferably to be taken in this case similarly as in the case of ships which counteract corrosion, for example, a cathodic corrosion protection or the use of a sacrificial anode. Simple protective paints, in contrast, could reduce the desired heat exchange and are therefore rather not to be recommended, unless the protective paint is adapted and suitable at least with respect to the influence on the heat exchange to be achieved. Sufficiently thin coatings can thus advantageously be used against so-called fouling, which do not noticeably prevent the heat exchange. This soiling of heat exchangers and heat transmitters, called “fouling”, and the cleaning resulting therefrom represent a challenge for operation again and again. Water having high salt content, high temperatures, and dirt in the water are responsible for the different deposits. They obstruct both the heating performance and the cooling performance of a heat exchanger. The more solid and thick the deposits become, the worse the heat exchange becomes.

In one particularly advantageous embodiment, the corrosion protection layer comprises titanium. It can also be made of titanium. It is also possible in one embodiment for the extensive heat exchanger to use pipelines made of titanium overall.

If titanium is used as the material for the extensive heat exchanger, such additional corrosion protection layers or anti-fouling paints can be omitted and this type of the design is therefore particularly advantageous. Titanium displays very good corrosion resistance to ocean water. If titanium pipes are used, it is preferred to avoid an electrical contact to steel components by way of suitable insulators for isolating the materials. Otherwise, there would be the potential that so-called local elements form, which can induce appearances of corrosion. Local elements are generally small-area corrosion elements (contact elements), which can hardly be seen with the naked eye. Local elements can arise at contact points of two different metals due to the effect of moisture, for example, induced by aerosols, and often cause significant corrosion there.

In one advantageous embodiment, the extensive heat exchanger is arranged in a framework which surrounds the heat exchanger and holds the heat exchanger in position for the respective operating state via fasteners.

The housing and fastening of the heat exchanger in a framework significantly simplifies the immersion of the heat exchanger in the ocean water. Its manipulation or handling for various operating states is also greatly facilitated. In this way, a modular structure is implemented having a module comprising the heat exchanger and the framework as a structural unit and auxiliary attachments, such as fittings or flange connections for the pipelines for connection to the container of the offshore electrolysis plant.

The heat exchanger immersible in the ocean water is housed here in the framework, which preferably has the dimensions of a standard container of the logistics branch. It is thus particularly easily possible to transport the heat exchanger and to exchange it if needed after a specific operating time, which is advantageous for maintenance and service purposes.

The framework is therefore preferably fastened to the extensive heat exchanger such that if needed guiding or tilting out of the ocean water can be effectuated.

The framework having the extensive heat exchanger can preferably be tilted out via a rotatable fastening.

It is particularly expedient and advantageous to structurally embody the extensive heat exchanger to be immersed in the ocean water such that it can be “swung out” or tilted out of the water using simple means, for example, with the aid of a winch. This can preferably be implemented by a rotatable or rotatable/tiltable fastening device on the framework.

The possibility of swinging the extensive heat exchanger out of the ocean water is a particularly advantageous structural refinement, in particular especially in the case of the requirements in the offshore area for an offshore electrolysis plant. Alternative pipe guides for the heat exchanger are conceivable which manage without the removal of pipe pieces for the swinging out of the heat exchanger. The framework enclosing the heat exchanger can thus be tilted via the rotatable fastening, for example. With a corresponding flange connection in each case for the supply line and the return line, which are attached and oriented exactly on the corresponding axis of rotation, the flange only has to be opened and provided with blind plates for swinging out. Flexible hoses or folding bellows systems or combinations made up of these line elements as a connection to the container having the electrolyzer are also usable within the meaning of the invention in order to enable swinging up or tilting out without a pipeline having to be detached, disconnected, or closed. Such hoses can also be manufactured from suitable plastic depending on the temperature level of the coolant in the supply line and in the return line of the coolant circuit.

The offshore electrolysis plant is embodied in a particularly advantageous embodiment having a connection unit for feeding electric current from an offshore wind turbine.

Excess current can thus be used in an offshore wind turbine directly on the ocean for hydrogen production in that the current is supplied via the connection unit to the offshore electrolysis plant.

This combination of renewable energies and hydrogen production in offshore wind parks and other wind power plants located in remote regions is particularly advantageous. This is because up to this point the strengthened buildout of renewable energies has also suffered from the lack of grid infrastructure. In Germany, for example, power lines for bringing the wind power from the ocean onto land and further to southern Germany are lacking. An offshore electrolysis plant can help here. Using it, the current generated on the ocean can in future be used directly on location for splitting ocean water.

In one embodiment, the offshore electrolysis plant according to the invention is therefore installed on an offshore platform in the ocean. Disused oil or gas platforms could be used as a base for such wind power electrolysis, for example, as are abundantly present, inter alia, in the North Sea. The hydrogen produced there may then be guided comfortably via the existing natural gas pipelines to power plants on land.

In the method for operating an offshore electrolysis plant having an electrolyzer arranged in a container, a coolant is guided in a closed coolant circuit from the container for the heat absorption and dissipation of process heat from the electrolysis, wherein a coolant pump arranged in the container is operated. As already stated in the case of the offshore electrolysis plant, a coolant pump arranged in the container is also to be understood in principle as a fixed coupling directly onto the container from the outside by tight flanging on of the coolant pump, so that then a housing unit of the coolant pump with the container is formed. This is to be understood in the scope of the invention such that even upon flanging or coupling of the coolant pump on the container, the electrolyzer and the coolant pump are housed in the same container, wherein a housing unit is formed.

In this case, in a particularly advantageous embodiment of the method, heat is transferred to ocean water in the closed coolant circuit from the coolant heated by the process heat and the coolant is thus cooled.

A damaging penetration of ocean water into the coolant circuit is preferably monitored. For this purpose, a corresponding sensor for detecting leaks in the coolant circuit can be applied and used. A measurement of the electrical conductivity is preferably carried out using a conductivity sensor, which reacts appropriately sensitively to a salt content caused by ocean water so that undesired penetration of ocean water is indicated and corresponding countermeasures can be taken.

### BRIEF DESCRIPTION OF THE FIGURES

Exemplary embodiments of the invention will be explained in more detail on the basis of a drawing. In the schematic and greatly simplified figures:

FIG. 1 shows an electrolysis plant having air cooling;

FIG. 2 shows an offshore electrolysis plant with use of ocean water as a coolant in an open coolant circuit;

FIG. 3 shows an exemplary embodiment of an offshore electrolysis plant according to the invention having a closed coolant circuit;

FIG. 4 shows a further exemplary embodiment of an offshore electrolysis plant according to the invention.

Identical reference signs have identical meanings in the figures.

### DESCRIPTION OF THE FIGURES

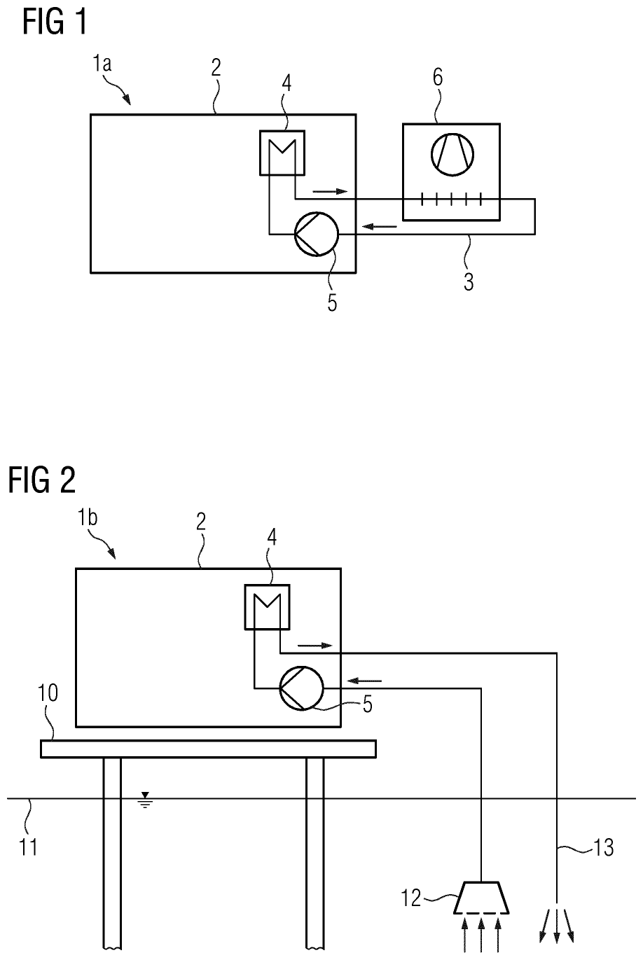

FIG. 1 shows an electrolysis plant 1a, in which an electrolyzer (not shown in more detail), for example, a PEM or alkali electrolyzer, is arranged in a container 2 or other housing. The electrolyzer is designed for producing hydrogen as a product of electrolysis from water as the educt. The electrolysis plant 1a has an air cooler 6 for cooling and heat dissipation of the process heat during operation of the electrolyzer. A coolant circuit 3 ensures the circulation of a coolant, wherein a medium to be cooled is guided through a heat exchanger 4 having correspondingly large heat exchanger surfaces to the atmosphere. A coolant pump 5 conveys the coolant. This configuration is disadvantageous for a use of the electrolysis plant 1a in the offshore area on the ocean and is therefore not to be recommended for offshore use. Since the ocean water is distributed in the form of salty aerosols by wind and weather, the heat exchanger surfaces and the associated external fans of the electrolysis plant 1a would be subjected to a very aggressive environment. High corrosion rates are to be expected here, which would impair the safe operation of the electrolysis plant 1a and would result in short service lives with high maintenance expenditure during offshore operation.

FIG. 2 shows an offshore electrolysis plant 1b, in which an electrolyzer (not shown), for example, a PEM or alkali electrolyzer, is arranged in a container 2. The offshore electrolysis plant 1b is arranged on a support structure 10, an offshore platform, which is located above sea level 11 and is anchored on the ocean floor. An electrolyzer (not shown in more detail), a coolant pump 5, and a heat exchanger (4) are provided in the container 2. Ocean water is used as the coolant and pumped up out of the ocean by means of the coolant pump 5 for cooling purposes to the heat exchanger 4. An intake nozzle 12 underwater in the suction line leading to the heat exchanger 4, in which the coolant pump 5 is installed, is provided as the supply for the ocean water. The coolant pump has to be designed as appropriately high-performance due to the height difference. If the coolant pump 5, as shown in FIG. 2, is to be arranged inside the container 2, the case can even occur with an excessive height difference that the vapor pressure of the ocean water has a limiting effect and cavitation occurs. In this case, it would not be possible to suck in the ocean water even using the strongest pumps, which is very disadvantageous for efficient cooling operation. Alternatively, the pump would have to be placed closer to the water surface, where it would possibly be subjected to the environmental influences more strongly and the access for maintenance and repair would also be made more difficult. To return the ocean water after the heat absorption in the heat exchanger 4, the return line 13 is connected on the outflow side from the heat exchanger (4). The return line 13 plunges below sea level 11 and returns the heated ocean water again. An open cooling concept is implemented in this way in the offshore electrolysis plant 1b, which makes use of ocean water as the coolant and is rather disadvantageous not only under environmental aspects in the maritime area, but also with respect to the operational reliability or service lives, which will be explained hereinafter on the basis of several selected aspects:

In operation of the electrolyzer, ocean water is sucked in through the intake nozzle 12 lying below sea level 11 with the aid of the high-performance coolant pump 5 and conveyed through the heat exchanger 4. On the opposite side of the heat exchanger 4, the medium of the electrolyzer to be cooled is conducted (not shown in FIG. 2), so that the heat is transferred directly to the ocean water as the coolant. The heated ocean water is returned back into the ocean via the return line 13 through an outlet opening. This cooling concept is accompanied by disadvantages. To avoid blockages or defects on the coolant pump 5, it has to be ensured that no large foreign bodies or even ocean living beings are sucked in. This can be carried out using complex filter systems, wherein these can clog over time and therefore have to be cleaned regularly. This requires a significant work effort, connected to high maintenance and service costs, and requires frequent work on location. Furthermore, even with ultrafine filters, interfering layers form “scaling” in the interior of the lines guiding the coolant and the heat exchanger 4. These layers can be so-called biofouling, wherein inorganic layers also form, however. Inorganic deposits occur in particular due to an unfavorable temperature dependence of the solubility of calcite. Calcite preferably forms at warmer points, thus in the interior of the heat exchanger 4, where such layers are particularly disturbing and cleaning is only possible with difficulty or not at all due to the poor accessibility.

Furthermore, there can be rules and regulations which forbid a return of large quantities of heated water into the ocean to protect flora and fauna. In particular in the case of electrolyzers having high performance, such rules could significantly limit operation. These problems are overcome in offshore electrolysis plants by the cooling concept of the invention:

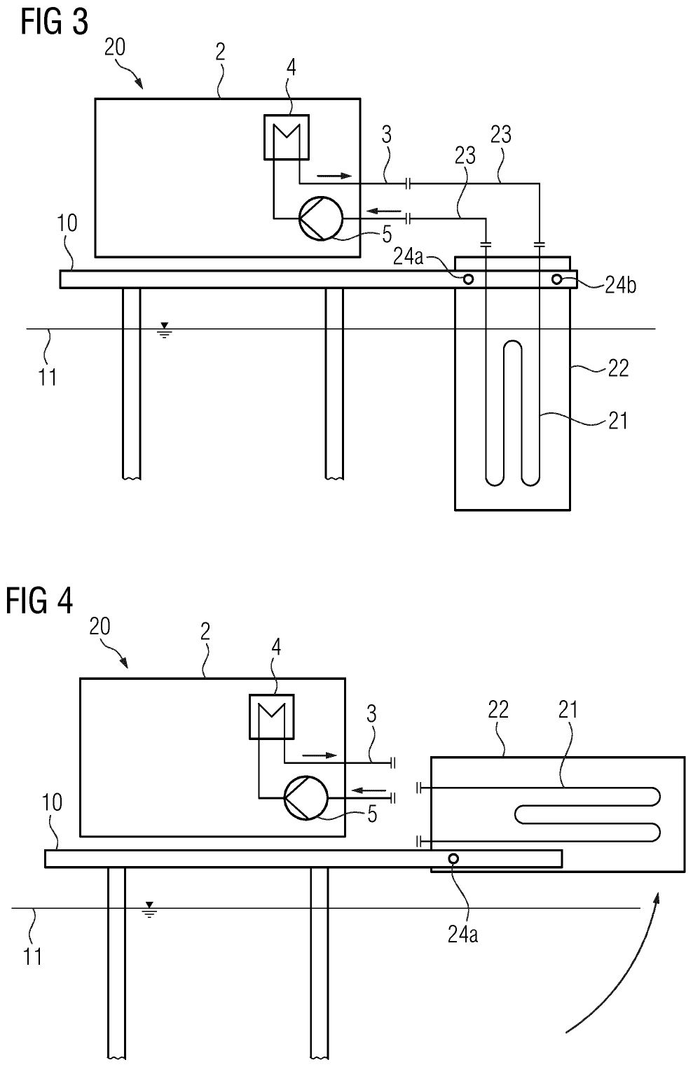

FIG. 3 shows an offshore electrolysis plant 20 according to the invention. This electrolysis plant 20 overcomes in particular the disadvantages of the embodiments described in the above FIG. 1 and FIG. 2. Accordingly, the offshore electrolysis plant 20 shows a container 2, in which an electrolyzer (not shown in more detail), for example, a PEM or alkali electrolyzer is arranged. The offshore electrolysis plant 20 is arranged on a support structure 10, an offshore platform, and is conceived for offshore use. A coolant pump (5) and a heat exchanger 4 are arranged in the container 2. A closed coolant circuit 3 is implemented, wherein an extensive heat exchanger 21 is installable in a flow-tight manner in the present case via removable pipelines 23 in the coolant circuit 3, so that in operation a coolant can be guided through the coolant pump 5 in a closed coolant circuit 3. The extensive heat exchanger 21 is arranged in a framework 22, fastened, and accordingly positioned ready for use. The structural unit made up of framework 22 and extensive heat exchanger 21 is detachably fastened by means of fasteners 24a, 24b on the support structure 10. The extensive heat exchanger 21 plunges below sea level 11 here. The extensive heat exchanger 21 in the framework 22 is arranged such that the framework 22 encloses the heat exchanger 21 and holds the heat exchanger 21 in position for the respective operating state via the fasteners 24a, 24b. The operating position of the extensive heat exchanger 21 is thus flexibly adjustable with immersion in the ocean water or also inspection or maintenance positions.

A particularly efficient heat sink is implemented by the ocean water, so that process heat from the electrolysis can be discharged from the container (2) and can be supplied to the ocean water solely via convection. Due to the closed coolant circuit (3), no harmful material exchange takes place between the coolant circulated in the circuit and the ocean water. These areas are fluidically separated from one another.

To provide a correspondingly large heat exchange surface and heat exchange efficiency, the heat exchanger 21 has a pipeline, which is embodied having ribs and/or fins on the coolant-guiding pipe outer surface and/or is guided in a large number of pipe curves. This specific and particularly advantageous embodiment is not illustrated in more detail in FIG. 3 for reasons of clarity. The pipeline is made of steel and has a corrosion protection layer on the outer surface.

The invention therefore provides the use of ocean water as a heat sink in a reservoir of nearly unlimited size as a cooling medium, wherein using a closed coolant circuit (3), only the heat is transferred to the ocean water and emitted thereto by the heat exchanger (21) immersed in the ocean. High cooling performances for offshore electrolysis are hereby implementable and large heat flows from high-performance offshore electrolyzers are transferable via the coolant to the ocean water. The impact of this design under environmental aspects is minor, in particular since a material decoupling of coolant and ocean water is provided. In particular because no ocean water is sucked in and instead a closed coolant circuit 3 is provided, the numerous problems described in operation are avoided. No foreign bodies can be sucked in, no undesired inorganic layers or biofouling can form in the interior of the heat exchanger 21, which increases the operational reliability. Suitably finished pivot devices and/or lifting tools or winches are provided on the offshore electrolysis plant for the immersibility of the heat exchanger 21 in the ocean water, which enable corresponding movements of the heat exchanger 21 such as immersing or lifting out. It is thus possible, if needed, after a specific operating time of the offshore electrolysis plant 20, to exchange the heat exchanger 21 or subject it to maintenance.

FIG. 4 shows a further exemplary embodiment in a particularly advantageous design of an offshore electrolysis plant 20 according to the invention. In contrast to the exemplary embodiment in FIG. 3, in this case the framework 22 is fastened to the heat exchanger 21 such that if needed guiding out, tilting out, or swinging out of the ocean water can be effectuated. For this purpose, a rotatable fastening 24a of the structural unit, comprising the framework 22 having the extensive heat exchanger 21 on the structure 10, is provided. This advantageous refinement opens up the possibility of swinging out the heat exchanger 21 if needed from the ocean water flexibly via a rotating mechanism, which significantly facilitates the handling. Alternative pipe guides for the heat exchanger are possible here, which manage without the removal of the removable pipe pieces 23—corresponding to the exemplary embodiment in FIG. 3.

The offshore electrolysis plant according to FIG. 3 and FIG. 4 is equipped with a connection unit—not shown in more detail—for feeding electric current from an offshore wind turbine. An offshore wind turbine can be set up here on the same support structure 10 together with the offshore electrolysis plant 20 comprising the container 2, so that a direct electrical connection and feeding of electrolysis current generated by the offshore wind turbine is possible.

During operation of the offshore electrolysis plant 20 for hydrogen production, the electrolyzer arranged in the container 2 is cooled to dissipate the process heat. The coolant is guided in a closed coolant circuit 3 from the container 2 in this case for the heat absorption and discharge of the process heat from the electrolysis and the container 2 is effectively cooled with its installations, in particular the electrolyzer. Heat is transferred to ocean water in this case in the closed coolant circuit 3 from the coolant heated by the process heat from the electrolysis and the coolant is thus cooled. A damaging penetration of ocean water into the coolant circuit 3 or other undesired leaks in the coolant circuit are monitored.

1. An offshore electrolysis plant comprising an electrolyzer arranged in a container and a heat exchanger, which is designed for heat absorption and discharge of process heat from the electrolysis in a closed coolant circuit from the container, characterized in that a coolant pump for conveying the coolant in the coolant circuit is arranged in the container.

2. The offshore electrolysis plant as claimed in claim 1, in which a heat exchanger, which is immersible in the ocean, is provided in the closed coolant circuit for the heat dissipation of the process heat absorbed by the coolant.

3. The offshore electrolysis plant as claimed in claim 2, in which to provide a large heat exchanger surface, the heat exchanger has a pipeline, which is embodied having ribs and/or fins on the coolant-guiding pipe outer surface and/or is guided in a large number of pipe curves.

4. The offshore electrolysis plant as claimed in claim 3, in which the pipeline is made of steel, wherein the pipeline has a corrosion protection layer on the outer surface.

5. The offshore electrolysis plant as claimed in claim 4, in which the corrosion protection layer comprises titanium.

6. The offshore electrolysis plant as claimed in claim 2, wherein the heat exchanger is arranged in a framework, which encloses the heat exchanger and holds the heat exchanger in position for the respective operating state via fasteners.

7. The offshore electrolysis plant as claimed in claim 6, in which the framework having the heat exchanger is fastened such that if needed guiding or tilting out of the ocean water can be effectuated.

8. The offshore electrolysis plant as claimed in claim 6, in which the framework having the heat exchanger can be tilted out via a rotatable fastener.

9. The offshore electrolysis plant as claimed in claim 1, having a connection unit for feeding electric current from an offshore wind turbine.

10. A method for operating an offshore electrolysis plant having an electrolyzer arranged in a container, in which coolant is guided out of the container in a closed coolant circuit for the heat absorption and discharge of process heat from the electrolysis, wherein a coolant pump arranged in the container is operated.

11. The method as claimed in claim 10, in which heat is transferred to ocean water in the closed coolant circuit from the coolant heated by the process heat and the coolant is thus cooled.

12. The method as claimed in claim 10, in which a damaging penetration of ocean water into the coolant circuit is monitored.
